(19) United States
(12) Patent Application Publication
(10) Pub. No.: US 2025/0060861 A1
(43) Pub. Date: Feb. 20, 2025

(54) ARTIFICIAL INTELLIGENCE-BASED TO-DO RECOMMENDATION DEVICE AND METHOD

(71) Applicants: Jae Ho CHOI, Seoul (KR); Seo Hyun CHOI, Seoul (KR); Delta PDS CO., LTD., Seoul (KR)

(72) Inventors: Jae Ho CHOI, Seoul (KR); Seo Hyun CHOI, Seoul (KR)

(73) Assignees: Jae Ho CHOI, Seoul (KR); Seo Hyun CHOI, Seoul (KR); Delta PDS CO., LTD., Seoul (KR)

(21) Appl. No.: 18/796,028

(22) Filed: Aug. 6, 2024

(30) Foreign Application Priority Data
Aug. 18, 2023 (KR) 10-2023-0108514
Oct. 12, 2023 (KR) 10-2023-0135922
Jun. 7, 2024 (KR) 10-2024-0074511
Jul. 12, 2024 (KR) 10-2024-0092524

(51) Int. Cl. G06F 3/0482; G06F 16/9535; G06F 40/166

(52) U.S. Cl. CPC G06F 3/0482; G06F 16/9535; G06F 40/166

(57) ABSTRACT

An artificial intelligence-based to-do recommendation device includes a memory and a processor electrically connected to the memory. The processor is configured to receive a user request for generation or retrieval of meeting minutes from a user terminal, generate the meeting minutes or a meeting minutes list including the meeting minutes according to the user request, generate to-do recommendations related to the contents of the meeting minutes through an artificial intelligence model when a to-do recommendation request related to the meeting minutes is received from the user terminal, and provide a to-do recommendation list including selection options for each to-do recommendation to the user terminal.

### CROSS-REFERENCE TO PRIOR APPLICATIONS

This application claims priority to Korean Patent Application Nos. 10-2023-0108514 (filed Aug. 18, 2023), 10-2023-0135922 (filed Oct. 12, 2023), 10-2024-0074511 (filed Jun. 7, 2024), and 10-2024-0092524 (filed Jul. 12, 2024), which are all hereby incorporated by reference in their entirety.

### BACKGROUND

The present disclosure relates to a to-do recommendation method and more specifically, to a method that supports effective fulfillment of a project and work by automatically recommending to-dos or supporting generation of tasks related to meeting minutes that records the contents of a meeting among project participants in the process of generating or retrieving the meeting minutes throughout the project duration.

In general, an Internet messenger is typically an application that transmits text or graphic messages between users and may function as a chat room in which multiple users participate. In one embodiment, the Internet messenger may be a mobile messenger executed in a mobile environment (e.g., a mobile phone) and may include a mobile application, such as KakaoTalk, Line, WeChat, or Facebook messenger. In addition, these Internet messengers are increasingly being utilized in a variety of ways in the management and progress of work.

In particular, as the scale of a project gradually increases and the structure of the project becomes more complex, the number of chat rooms in which work participants participate simultaneously within a single project is also increasing. It may make it challenging for work participants to easily understand the flow of related work amidst a distributed communication process across multiple chat rooms.

Accordingly, a range of tools are being developed to support communication among various project participants. For example, meeting minutes that record the contents of meetings may be summarized, stored, and shared among users to easily facilitate sharing of project progress.

Also, various tasks related to the contents of a meeting may be generated and shared among participants, and techniques to improve work efficiency in generating and managing tasks are required.

Related Art: Korean Patent No. 10-1182535 (Sep. 6, 2012)

### SUMMARY

In view of the above, an embodiment of the present disclosure provides an artificial intelligence-based to-do recommendation device and method that supports effective fulfillment of a project and work by automatically recommending to-dos or supporting generation of tasks related to meeting minutes that records the contents of a meeting among project participants in the process of generating or retrieving the meeting minutes throughout the project duration.

Among embodiments, an artificial intelligence-based to-do recommendation device may comprise a memory; and a processor electrically connected to the memory, wherein the processor is configured to receive a user request for generation or retrieval of meeting minutes from a user terminal, generate the meeting minutes or a meeting minutes list including the meeting minutes according to the user request, generate to-do recommendations related to the contents of the meeting minutes through an artificial intelligence model when a to-do recommendation request related to the meeting minutes is received from the user terminal, and provide a to-do recommendation list including selection options for each to-do recommendation to the user terminal.

The processor may receive from the user terminal a conversation recording file capturing a conversation among work participants regarding the meeting contents along with a user request for generation of meeting minutes, generate conversation text related to the meeting contents by converting the conversation recording file into text, and generate meeting minutes including a summary of the conversation text and selection options for each to-do recommendation.

The processor may transmit the conversation recording file to an external Speech-To-Text (STT) server and receive the conversation text from the STT server.

The processor may generate the meeting minutes list in response to a retrieval request from any one of work participants on a chat room or a meeting map for management of meeting minutes in which the work participants participate.

If the meeting minutes correspond to general meeting minutes, the processor may add the to-do recommendation list to the meeting minutes and convert the corresponding meeting minutes into to-do meeting minutes.

If a task is generated for a specific to-do recommendation included in the to-do meeting minutes, the processor may remove the specific to-do recommendation from the to-do recommendation list.

When all to-do recommendations are removed from the to-do recommendation list, the processor may convert the to-do meeting minutes into the general meeting minutes.

When a user selection is input through the selection option for each to-do recommendation, the processor may generate a task related to the corresponding to-do recommendation.

The processor may set the user who has entered the user selection as a task assigner of the task and set the corresponding to-do recommendation as the contents of the task.

When a plurality of selection options are selected by the user who has entered the user selection, the processor may sequentially generate tasks for each of the corresponding to-do recommendations.

The processor may receive the user's voice file related to the meeting contents from the user terminal, recognize the speech within the voice file to generate a script and a summary message converted to text, and display the summary message as a conversation message in a chat room selected by the user.

The processor may receive the user's speech through streaming from the user terminal in real-time and generate the voice file.

The processor may input the voice file into a pre-built speech recognition model to generate the script and the summary message, respectively.

The processor may generate a tag associated with the summary message to combine the tag with the summary message and provide a retrieval function for the summary message through the tag.

The processor may assign and store a favorites function to each conversation message and provide a list of conversation messages to which the favorites functions have been assigned through a favorites page.

Among embodiments, in an artificial intelligence-based to-do recommendation method performed in a to-do recommendation device comprising a memory and a processor electrically connected to the memory, the method, performed by the processor, comprises receiving a user request for generation or retrieval of meeting minutes from a user terminal; generating the meeting minutes or a meeting minutes list including the meeting minutes according to the user request; and generating to-do recommendations related to the contents of the meeting minutes through an artificial intelligence model when a to-do recommendation request related to the meeting minutes is received from the user terminal and providing a to-do recommendation list including selection options for each to-do recommendation to the user terminal.

The present disclosure may provide the following effects. However, since it is not meant that a specific embodiment has to provide all of or only the following effects, the technical scope of the present disclosure should not be regarded as being limited by the specific embodiment.

An artificial intelligence-based to-do recommendation device and method according to one embodiment of the present disclosure may automatically recommend to-dos or support generation of tasks related to meeting minutes that records the contents of a meeting among work participants in the process of generating or retrieving the meeting minutes throughout the project duration, thereby supporting effective fulfillment of the project and work.

### BRIEF DESCRIPTION OF THE DRAWINGS

FIG. 1 illustrates a to-do recommendation system according to the present disclosure.

FIG. 2 illustrates a system structure of the to-do recommendation system of FIG. 1.

FIG. 3 illustrates a functional structure of the processor of FIG. 2.

FIG. 4 is a flow diagram illustrating an artificial intelligence-based to-do recommendation method according to the present disclosure.

FIG. 5 illustrates one embodiment of meeting minutes according to the present disclosure.

FIG. 6 illustrates one embodiment of a process for generating meeting minutes according to the present disclosure.

FIG. 7 illustrates one embodiment of a process for generating conversation messages according to the present disclosure.

FIG. 8 illustrates one embodiment of a process for providing related functions in a chat room according to the present disclosure.

FIG. 9 illustrates one embodiment of a task generation process according to the present disclosure.

FIG. 10 illustrates one embodiment of a process for modifying a task according to the present disclosure.

FIG. 11 illustrates general meeting minutes and to-do meeting minutes according to the present disclosure.

FIG. 12 illustrates one embodiment of a process for updating a to-do recommendation list according to the present disclosure.

FIG. 13 illustrates a process of sharing conversation messages derived from user speech in a chat room according to the present disclosure.

FIG. 14 illustrates one embodiment of a detailed view page of a conversation message according to the present disclosure.

### DETAILED DESCRIPTION

Since the description of the present disclosure is merely an embodiment for structural or functional explanation, the scope of the present disclosure should not be construed as being limited by the embodiments described in the text. That is, since the embodiments may be variously modified and may have various forms, the scope of the present disclosure should be construed as including equivalents capable of realizing the technical idea. In addition, a specific embodiment is not construed as including all the objects or effects presented in the present disclosure or only the effects, and therefore the scope of the present disclosure should not be understood as being limited thereto.

On the other hand, the meaning of the terms described in the present application should be understood as follows.

Terms such as “first” and “second” are intended to distinguish one component from another component, and the scope of the present disclosure should not be limited by these terms. For example, a first component may be named a second component and the second component may also be similarly named the first component.

It is to be understood that when one element is referred to as being “connected to” another element, it may be connected directly to or coupled directly to another element or be connected to another element, having the other element intervening therebetween. On the other hand, it is to be understood that when one element is referred to as being “connected directly to” another element, it may be connected to or coupled to another element without the other element intervening therebetween. Meanwhile, other expressions describing a relationship between components, that is, “between,” “directly between,” “neighboring to,” “directly neighboring to,” and the like, should be similarly interpreted.

It should be understood that the singular expression includes the plural expression unless the context clearly indicates otherwise, and it will be further understood that the terms “comprises” or “have” used in this specification, specify the presence of stated features, numerals, steps, operations, components, parts, or a combination thereof, but do not preclude the presence or addition of one or more other features, numerals, steps, operations, components, parts, or a combination thereof.

Identification symbols (for example, a, b, and c) for individual steps are used for the convenience of description. The identification symbols are not intended to describe an operation order of the steps. Therefore, unless otherwise explicitly indicated in the context of the description, the steps may be executed differently from the stated order. In other words, the respective steps may be performed in the same order as stated in the description, actually performed simultaneously, or performed in reverse order.

The present disclosure may be implemented in the form of program code in a computer-readable recording medium. A computer-readable recording medium includes all kinds of recording devices storing data that a computer system may read. Examples of a computer-readable recording medium include a ROM, a RAM, a CD-ROM, a magnetic tape, a floppy disk, and an optical data storage device. Also, the computer-readable recording medium may be distributed over computer systems connected through a network so that computer-readable code may be stored and executed in a distributed manner.

Unless defined otherwise, all the terms used in the present disclosure provide the same meaning as understood generally by those skilled in the art to which the present disclosure belongs. Those terms defined in ordinary dictionaries should be interpreted to have the same meaning as conveyed in the context of related technology. Unless otherwise defined explicitly in the present disclosure, those terms should not be interpreted to have ideal or excessively formal meaning.

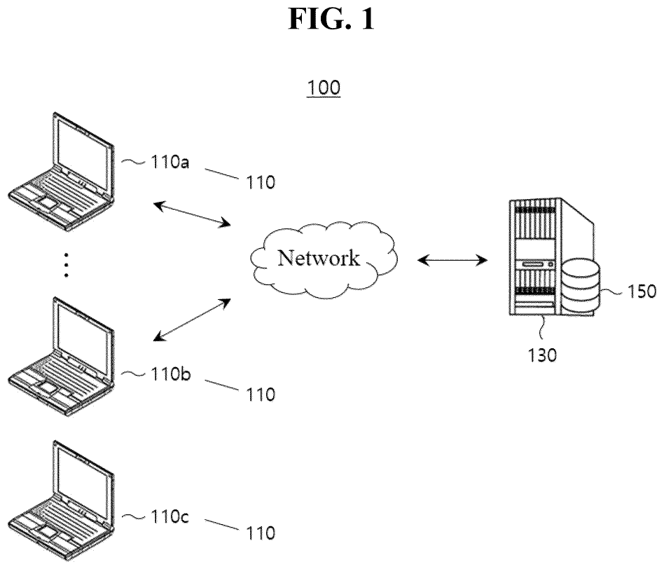

FIG. 1 illustrates a to-do recommendation system according to the present disclosure.

Referring to FIG. 1, the to-do recommendation system 100 may comprise a plurality of user terminals 110, a to-do recommendation device 130, and a database 150.

The user terminal 110 may correspond to a computing device operated by a user. For example, the user terminal 110 may be a desktop, laptop, tablet PC, or smartphone; however, it is not necessarily limited to the specific examples and may be implemented as various other devices.

The user terminal 110 may include one or more terminals; in this case, the user terminal 110 may include one or more than one of a first user terminal 110a, a second user terminal 110b, and a third user terminal 110c. For the sake of convenience, the user terminal 110 used by a first user may be referred to as the first user terminal 110a, the user terminal 110 used by a second user as the second user terminal 110b, and the user terminal 110 used by a third user is 110 as the third user terminal 110c.

In an embodiment of the present disclosure, a plurality of users may be included in one or more user groups. The user groups may be referred to as a first user group, a second user group, a third user group, and so on. Meanwhile, one user may belong to one or more user groups at the same time.

Also, a plurality of users may correspond to work participants involved in a common project or task. For example, work participants may include a task assigner who assigns the task, a task performer who performs the task, and a task-related individual related to the task.

At this time, a single overarching project may exist, including a plurality of work projects carried out independently. Also, plans, cards, notes, or tasks may be generated and stored in association with either the entire project or individual work projects.

Here, a plan may correspond to a work plan established to achieve a specific goal, a card may correspond to a management card for a series of tasks, and a note may correspond to a work record that stores work-related contents, and a task may correspond to a unit of work generated and processed according to a plan, card, or note.

Also, during the processing of plans, cards, notes, or tasks, objects such as messages, files, photos (or videos) may be shared among users, and a chat room may be provided for conversation and object sharing among the users. At this time, messages shared through the chat room may include everyday conversation messages and work messages related to work discussions.

In one embodiment, at least one of the user terminals 110 may be a mobile terminal and connected to the to-do recommendation device 130 through cellular communication or Wi-Fi communication. In another embodiment, at least one of the user terminals 110 may be a desktop and connected to the to-do recommendation device 130 via the Internet.

The to-do recommendation device 130 may correspond to a computing device that may be connected to at least one user terminal 110 through a network. In one embodiment, the to-do recommendation device 130 may manage at least one or more user groups, each of which includes a user and other associated users as members, namely, work participants.

In one embodiment, the to-do recommendation device 130 may be connected to the user terminal 110 through a dedicated agent installed on the user terminal 110. Here, the dedicated agent may correspond to an agent program, which is software that, when installed on the user terminal 110, enables interaction between the user terminal 110 and the to-do recommendation device 130 under the approval of the user terminal 110.

Meanwhile, the connection and interaction between the to-do recommendation device 130 and the user terminal 110 described herein may correspond to one embodiment and may be applied in various other forms within a typical range depending on various operational and implementation environments.

The database 150 may correspond to a storage device that stores various information required during the operation of the to-do recommendation device 130. For example, the database 150 may store conversation recording files capturing meeting discussions, voice files of users, or text information converted through speech recognition; however, the type of information stored is not necessarily limited to the examples above, and the database 150 may store information collected or processed in various forms during the process of performing the artificial intelligence-based to-do recommendation method according to the present disclosure.

Also, in FIG. 1, the database 150 is shown as a logical storage device included in the to-do recommendation device 130; however, the database 150 is not necessarily limited to the specific implementation and may be implemented as a device separate from the to-do recommendation device 130.

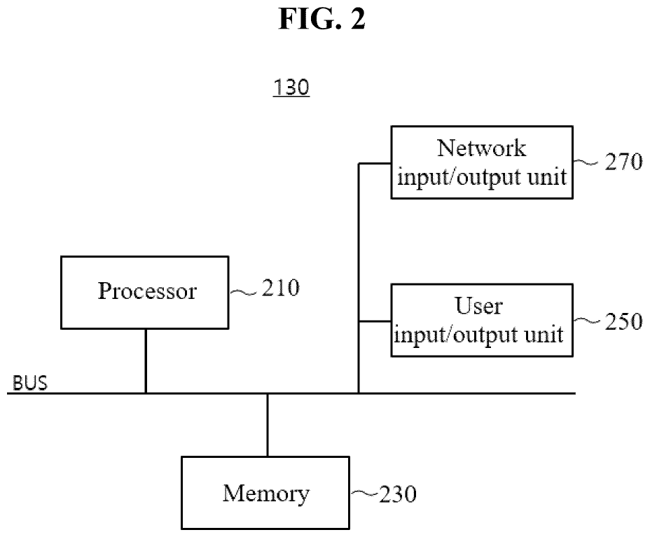

FIG. 2 illustrates a system structure of the to-do recommendation system of FIG. 1.

Referring to FIG. 2, the to-do recommendation device 130 may include a processor 210, a memory 230, a user input/output unit 250, and a network input/output unit 270.

The processor 210 may execute the artificial intelligence-based to-do recommendation procedure according to the present disclosure, manage the memory 230 read or written during the execution, and schedule the synchronization between the volatile and non-volatile memory within the memory 230.

The processor 210 may control the overall operation of the to-do recommendation device 130; by being electrically connected to the memory 230, the user input/output unit 250, and the network input/output unit 270, the processor 210 may control the data flow among them. The processor 210 may be implemented as a Central Processing Unit (CPU) or a Graphics Processing Unit (GPU) of the to-do recommendation device 130.

The memory 230 may be implemented as non-volatile memory such as a solid-state disk (SSD) or a hard disk drive (HDD) and may include an auxiliary memory device used to store all data required for the to-do recommendation device 130 as well as main memory implemented as volatile memory, such as Random Access Memory (RAM). In this way, the memory 230 may be implemented as a combination of volatile and non-volatile memory; if implemented as non-volatile memory, the memory 230 may be connected through a hyperlink.

The user input/output unit 250 may include an environment for receiving user input and an environment for outputting specific information to the user, for example, an input device that includes or connects to an adaptor such as a mouse, trackball, touch pad, graphic tablet, scanner, touch screen, keyboard, or pointing device and an output device that includes an adaptor such as a monitor or a touchscreen. In one embodiment, the user input/output unit 250 may correspond to a computing device connected through a remote connection; in this case, the to-do recommendation device 130 may function as a server.

The network input/output unit 270 may provide a communication environment for connecting to the user terminal 110 through a network and may include adaptors for communication through, for example, Local Area Network (LAN), Metropolitan Area Network (MAN), Wide Area Network (WAN), and Value-Added Network (VAN). Also, the network input/output unit 270 may be implemented to provide wireless data transmission via Wi-Fi, short-range communication functions using Bluetooth, or wireless communication functions of 4G or higher.

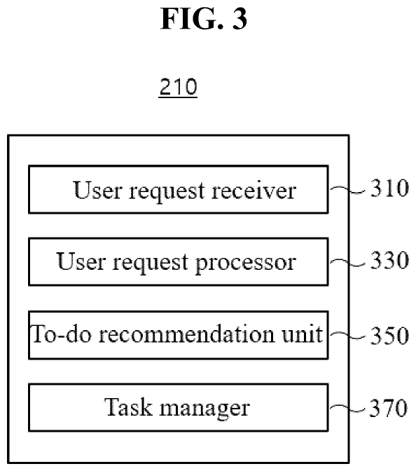

FIG. 3 illustrates a functional structure of the processor of FIG. 2.

Referring to FIG. 3, the to-do recommendation device 130 may perform the artificial intelligence-based to-do recommendation method according to the present disclosure through the processor 210. To this end, the processor 210 may include a user request receiver 310, a user request processor 330, a to-do recommendation unit 350, a task manager 370, and a controller (not shown in FIG. 3).

At this time, the embodiment of the present disclosure does not need to include all the functional components at the same time, and depending on embodiments, part of the components above may be omitted, or all or part of the components above may be selectively implemented. Also, one embodiment of the present disclosure may be implemented as an independent module that selectively includes part of the components above, and the artificial intelligence-based to-do recommendation method according to the present disclosure may be performed through interoperation among individual modules. In what follows, the operation of each component will be described in detail.

The user request receiver 310 may receive a user request for generation or retrieval of meeting minutes from the user terminal 110. Here, meeting minutes may correspond to work records that document the meeting contents discussed during a meeting among work participants and may correspond to a type of note generated in conjunction with the overall project or work project. Also, the user request may involve a command or information that the user requests the system to perform in relation to the meeting minutes and may be generated by the user (e.g., a work participant) on the user terminal 110. In other words, the user request may include generating, retrieving, deleting, or modifying meeting minutes. The user request receiver 310 may receive and interpret a user request input from the user terminal 110 and then support execution of a series of operations related to the request. The user request receiver 310 may interpret the user request and determine the type of user request, target meeting minutes, requested tasks, and so on.

Also, the user request receiver 310 may operate in conjunction with separate modules to process user requests. For example, when a request to generate meeting minutes is received, the user request receiver 310 may invoke a meeting minutes generation module to initiate the meeting minutes generation operation. In the case of a meeting minutes retrieval request, the user request receiver 310 may initiate a meeting minutes retrieval operation by invoking the meeting minutes retrieval module. The user request receiver 310 may provide the user terminal 110 with an interface for inputting requests for generating or retrieving meeting minutes, and the corresponding interface may be implemented through an application running on the user terminal 110.

In one embodiment, the user request receiver 310 may receive from the user terminal 110 a conversation recording file capturing a conversation among work participants regarding meeting contents along with a user request for generating meeting minutes. In particular, the user request receiver 310 may receive from the user terminal 110 a conversation recording file capturing a conversation among work participants regarding meeting contents in conjunction with the user terminal 110. At this time, the conversation recording file may correspond to a file that records conversation speeches among work participants involved in the meeting, and the conversation speeches may be recorded using the recording function included in the user terminal 110. The user request receiver 310 may directly receive a conversation recording file from the user terminal 110 or record the conversation contents transmitted in real-time from the user terminal 110 to generate a conversation recording file.

In one embodiment, the user request receiver 310 may receive the user's voice file related to the meeting contents from the user terminal 110. Here, the voice file may correspond to a file that records user's speech and may be recorded using a recording function included in the user terminal 110. The user may record the speech directly through the user terminal 110 to generate a voice file or may select and transmit one of various voice files stored in the user terminal 110.

Also, the user request receiver 310 may receive the user's speech streamed in real-time from the user terminal 110 and directly generate a voice file. In other words, the user may directly record his or her speech on the user terminal 110 equipped with a speech recording function, such as a smartphone, a tablet, or a PC; the user request receiver 310 may receive in real-time the user's speech recorded in conjunction with the user terminal 110 through streaming and generate files in speech data formats such as WAV and MP3. At this time, the user request receiver 310 may save storage space for voice files by compressing speech data received in real-time and may determine the compression method based on the network conditions.

The user request processor 330 may generate meeting minutes or a meeting minutes list including the meeting minutes according to the user request. Specifically, the user request processor 330 may generate meeting minutes that capture meeting contents according to a request for generating meeting minutes. At this time, the meeting minutes may be generated manually by work participants involved in the meeting or automatically generated by artificial intelligence based on a file recording the meeting discussions, and the generated meeting minutes may be stored and managed in the database 150. Also, the user request processor 330 may retrieve the meeting minutes according to a meeting minutes retrieval request and generate a list of one or more meeting minutes as a retrieval result. In other words, the meeting minutes list may correspond to a list of meeting minutes generated as a retrieval result.

More specifically, when a conversation recording file is received according to a request for generating meeting minutes, the user request processor 330 may convert the conversation recording file into conversation text on the meeting discussions and then generate meeting minutes that include a summary of the conversation text and selection options for the individual to-do recommendations. The user request processor 330 may recognize the speeches of work participants from conversation recording files using a Speech-To-Text (STT) algorithm or a speech recognition model and identify each work participant's conversation from the corresponding speech to generate text in the conversation form into conversation text. At this time, the conversation text may correspond to a text file generated by converting a conversation recorded during a meeting among work participants into text, which may be generated through an external Speech-To-Text (STT) server depending on the needs.

Also, conversation text may be used as input data for a text summary model, and the text summary model may generate a summary that summarizes the conversation text as output. Here, the text summary model may correspond to a language model that receives text or a text file as input and generates a summary that summarizes the text or text file. Also, the text summary model may be designed to generate a summary of meeting contents while simultaneously generating to-do recommendations related to the meeting contents.

For example, a text summary model may be implemented using ChatGPT. ChatGPT is a large language model and may correspond to an interactive artificial intelligence chatbot. In particular, GPT stands for ‘Generative Pre-trained Transformer’ and may correspond to generative AI that generates sentences by pre-training on a massive amount of data through machine learning. In this case, the text summary model may selectively generate at least one of a summary and to-do recommendations by setting data types and structure of the input and output.

In one embodiment, the user request processor 330 may transmit a conversation recording file to an external Speech-To-Text (STT) server and receive conversation text from the STT server. For example, the external STT server may include the CLOVA Speech server or the Whisper server that supports multilingual speech recognition. In other words, the user request processor 330 may generate conversation text on the meeting contents among work participants through the external STT server that provides an Automatic Speech Recognition (ASR) service.

In one embodiment, the user request processor 330 may insert meeting minutes into a chat room in which work participants are participating or a meeting map for managing meeting minutes depending on the location of a meeting minutes generation request. Here, the meeting map may correspond to a dedicated management tool for managing meeting minutes. Also, if meeting minutes are generated and inserted into a chat room according to a meeting minutes generation request, a message regarding the generation of meeting minutes may be shared through the chat room, and work participants may directly select the message to access the meeting minutes or download the meeting minutes file. Also, when meeting minutes are generated and inserted into the meeting map according to a meeting minutes generation request, various functions such as retrieval, modification, and deletion of meeting minutes may be performed through a dedicated interface. Meanwhile, meeting minutes inserted into the meeting map or chat room may be stored and managed through a separate memory area related to the meeting map or chat room.

In one embodiment, the user request processor 330 may generate a meeting minutes list according to a retrieval request from one of the work participants in a chat room in which work participants are participating or on a meeting map for managing meeting minutes. The user request processor 330 may provide an interface through which a meeting minutes retrieval request may be entered for each location that enables retrieval of meeting minutes, and the corresponding interface may be implemented through an application running on the user terminal 110. For example, work participants may activate the meeting minutes retrieval function through a menu in the chat room and activate the meeting minutes retrieval function through a dedicated interface provided on the meeting map.

Also, when meeting minutes are retrieved in the chat room according to a meeting minutes retrieval request, a meeting minutes list generated as a result of the retrieval may be shared through the chat room, and work participants may directly select specific meeting minutes from the meeting minutes list to access the corresponding meeting minutes or download a meeting minutes file. In this case, the meeting minutes list may be displayed in the form of a message within the chat room and may be displayed independently on the meeting map through a separate interface. In the meeting minutes list provided in the form of a list, meeting minutes may be sorted and displayed according to their generation time, or the meeting minutes may be sorted according to various other criteria other than the generation time.

Also, when meeting minutes are retrieved on the meeting map according to a meeting minutes retrieval request, various functions such as confirmation, modification, and deletion of individual meeting minutes along with a meeting minutes list may be executed through a dedicated interface. Meanwhile, the meeting minutes list retrieved within the meeting map or chat room may be temporarily generated, shared, and then deleted; if necessary, the meeting minutes list may be selectively stored and managed through a separate memory area related to the meeting map or chat room.

In one embodiment, the user request processor 330 may generate separate retrieval results for each type of meeting minutes. For example, the user request processor 330 may respond to a meeting minutes retrieval request and generate retrieval results by distinguishing between general and to-do minutes; in this case, a meeting minutes list may be generated separately for the general and to-do meeting minutes. Here, the general meeting minutes may correspond to meeting minutes that record usual meeting contents, while the to-do meeting minutes may include one or more to-do recommendations along with the usual meeting contents.

In one embodiment, when the user request processor 330 receives a user's voice file related to the meeting contents from the user terminal 110, the user request processor 330 may recognize speeches in the voice file, generate a script converted to text and a summary message, and display the summary message as a conversation message in the chat room selected by the user. In other words, the user request processor 330 may share the summary message generated by summarizing the script recognized from the user's speech as a conversation message to the chat room in which the user is participating. Also, here, the conversation message is a message shared within the chat room and may be defined as a voice memo.

At this time, other users participating in the chat room may recognize the corresponding conversation message as a message entered by the user. Through the process above, the user may easily convey recorded speech content to other users in the chat room via a conversation message (or voice memo) without entering a separate message within the chat room. The user request processor 330 may typically convert the text of a summary message into a conversation message and share the converted message in the chat room; if necessary, the user request processor 330 may also display images or videos related to the content of the summary message along with the conversation message.

More specifically, the user request processor 330 may analyze speech data stored in a voice file using various speech recognition algorithms and then convert the speech data into text. For example, the speech recognition process may include a speech analysis process that decomposes a speech signal into frequency and intensity elements, a speech interpretation process that interprets the speech signal using a trained model, and a speech conversion process that converts phonemes extracted through the model into text. Here, a script may correspond to the text generated by converting the user's speech stored in the voice file, and the summary message may correspond to a concise summary of the key points of the script.

Therefore, scripts and summary messages may be expressed in a text data format and stored and managed in association with the corresponding user or the corresponding voice file. For example, voice files associated with a specific user may be selectively retrieved; or scripts or summary messages associated with a specific voice file may be selectively retrieved.

In one embodiment, the user request processor 330 may input a voice file into a pre-built speech recognition model to generate a script and a summary message, respectively. The user request processor 330 may generate both a script and a summary message from a voice file using only the speech recognition model. To this end, the speech recognition model may be trained and built to receive a speech file as input data and generate output data that includes a script and a summary message. In this case, the speech recognition model may be implemented as a single model and, if necessary, may be implemented using a plurality of sub-models. For example, the speech recognition model may be implemented by including a first model that generates a script from a voice file and a second model that generates a summary message from the script; the speech recognition model may be implemented with a structure in which the output of the first model is fed to the input of the second model.

In one embodiment, when receiving a selection for a conversation message from a chat room participant, the user request processor 330 may display an interface related to the conversation message. In other words, each user participating in the chat room may directly select a shared conversation message, and when each user's selection is detected for each conversation message, the user request processor 330 may provide functions related to the corresponding conversation message through a separate interface. The interface may include basic functions such as copying, deleting, and sharing messages.

In one embodiment, the user request processor 330 may store and manage summary or conversation messages in the database 150. The user request processor 330 may assign a unique identifier to identify each message and store in the database 150 the date and time each message is generated, voice file or script information related to each message, and the content (i.e., text) of the message by associating them with each other. Also, the user request processor 330 may store and manage additional information such as tags and categories generated in association with each message. The user request processor 330 may provide management functions for handling each message, such as searching, deleting, modifying, sorting, and filtering.

In one embodiment, the user request processor 330 may generate a tag related to a summary message, combine the tag with the summary message, and provide a retrieval function for the summary message through the tag. The user request processor 330 may analyze the content of each message to extract main keywords to generate tags based on the extracted information, and then combine the generated tags with the corresponding message. At this time, the types of tags may include a subject tag indicating the subject of each message, an entity tag indicating a person, place, or object that appears in each message, and a description tag that briefly explains the content of each message. Also, the user request processor 330 may search for tagged messages through tags, filter search results using specific tags, and recommend messages based on the tags of interest to the user.

In one embodiment, in the process of providing at least one of a voice file, a script, and a summary message related to a conversation message through a detailed view page for the corresponding conversation message, the user request processor 330 may block other users from retrieving the corresponding voice file, script, or summary message according to private settings set by the user. The user request processor 330 may provide a detailed view function for each conversation message generated in conjunction with a voice file and shared within the chat room and provide a detailed view page to display the details of the corresponding conversation message within the chat room.

For example, user a may convert a voice file containing his or her recorded conversation into the text format and share the text through a chat room. Also, the user may configure settings to determine whether to disclose voice files, scripts, or summary messages related to the conversation message. In other words, if user a sets a voice file related to the conversation message m to private, the user a may still retrieve all the voice files, scripts, and summary messages; however, user b may only be able to retrieve the scripts and summary messages but not the restricted voice file.

In one embodiment, the user request processor 330 may selectively provide a message translation function in the process of providing details of a conversation message through the detailed view page for the conversation message. The user request processor 330 may provide a separate and dedicated interface for the detailed view page. In other words, the user request processor 330 may provide a message translation function among various features available within the interface for the detailed view page. To this end, the interface may be implemented to operate in conjunction with a translation engine. By selecting the message translation function, the user may receive a translation of the conversation message. The user request processor 330 may provide each conversation message along with its translation through the interface and may also display a specific conversation message by replacing the conversation message with its translated version. Meanwhile, the user request processor 330 may provide the same function for summary messages.

In one embodiment, the user request processor 330 may assign and store a favorites function for each conversation message and provide a list of conversation messages to which the favorites function has been assigned through a favorites page. Here, the favorites page may correspond to a dedicated interface that provides detailed operations and functions related to the favorites function. The favorites page may be provided within the chat room or through a separate interface outside the chat room. For example, the favorites page may provide a list of conversation messages with a favorites function for each chat room or across all chat rooms.

Meanwhile, the favorites function may correspond to a function that allows a user to easily retrieve and manage conversation messages by adding important or frequently used conversation messages to a separate list. In other words, users may assign the favorites function not only to their own conversation messages but also to the conversation messages generated by other users and shared through the chat room.

For example, the user request processor 330 may provide a favorites menu on the detailed view page for each conversation message, and the user may select the favorites menu to add the corresponding conversation message to the favorites list. The user request processor 330 may store the favorites list in association with user accounts. The user request processor 330 may provide the favorites list to the user terminal 110 through various interfaces.

Also, the user request processor 330 may sort the favorites list according to various criteria such as the order in which messages are added, order of title, or order of date and may remove specific conversation messages selected by the user from the favorites list. The user request processor 330 may manage important conversation messages through a separate favorites list for each chat room or for all chat rooms. The user request processor 330 may provide a function for sharing the favorites list with other users, provide a function for tagging the favorites list, and provide a notification to the user when a conversation message added to the favorites list is updated.

When the to-do recommendation unit 350 receives a to-do recommendation request related to the meeting minutes from the user terminal 110, the to-do recommendation unit 350 may generate to-do recommendations related to the meeting contents of the meeting minutes through an artificial intelligence model and provide the user terminal 110 with a to-do recommendation list that includes selection options for each to-do recommendation. The to-do recommendation unit 350 may receive a signal regarding a to-do recommendation request from the user terminal 110 and may initiate a response operation upon receiving the to-do recommendation request.

In this case, the artificial intelligence model for to-do recommendation may be implemented as a deep learning model that receives text related to the meeting contents as input and generates to-do recommendations as output; however, the artificial intelligence model is not necessarily limited to the specific example. Also, the artificial intelligence model may be built in conjunction with a to-do table that stores to-do recommendations, and in this case, the artificial intelligence model may generate index information of the table as to-do recommendation information. In other words, the to-do recommendation unit 350 may generate to-do recommendations by retrieving the to-do table based on the index information output by the artificial intelligence model.

Also, the to-do recommendation unit 350 may generate a to-do recommendation list that includes selection options for each to-do recommendation and provide the to-do recommendation list to the user terminal 110. Here, the selection option may correspond to a function activated according to the user's selection for each of one or more to-do recommendations. For example, selection options may be implemented as checkboxes. In other words, the to-do recommendation list may correspond to a list of to-do recommendations and may be expressed as a set of pairs, each of which consists of a to-do recommendation and a selection option. Users may individually select to-do recommendations through each selection option from the to-do recommendation list. The to-do recommendation unit 350 may generate a to-do recommendation list as a response to a to-do recommendation request and provide the to-do recommendation list to the user terminal 110; the to-do recommendation list may be displayed through a dedicated interface implemented on the user terminal 110.

In one embodiment, if the meeting minutes correspond to general meeting minutes, the to-do recommendation unit 350 may convert the corresponding meeting minutes into to-do meeting minutes by adding a to-do recommendation list to the meeting minutes. Here, general meeting minutes may correspond to meeting minutes that do not include to-do recommendations, and to-do meeting minutes may correspond to meeting minutes that include to-do recommendations. In other words, meeting minutes may be typically generated as general meeting minutes by default, and when to-do recommendations are generated in response to a user's (e.g., a work participant's) request for to-do recommendations, the to-do recommendations may be generated and managed as separate objects independently from the meeting minutes. At this time, the to-do recommendation unit 350 may add the generated to-do recommendation list to the meeting minutes if needed, and as a result of adding the to-do recommendation list to the meeting minutes, general meeting minutes may be converted into to-do meeting minutes. The to-do recommendation unit 350 may perform the operation of converting general meeting minutes into to-do meeting minutes when a user's request is received or predetermined conditions are met.

In one embodiment, the to-do recommendation unit 350 may remove a specific to-do recommendation from the to-do recommendation list when a task is generated for the specific to-do recommendation included in the to-do meeting minutes. For example, if meeting minutes A contain to-do recommendations a and b, and a user (e.g., a work participant) generates a task for the to-do recommendation b, to-do recommendation b may be removed from meeting minutes A. Afterwards, when meeting minutes A are retrieved, only to-do recommendation a may be retrieved along with meeting minutes A. Meanwhile, the to-do recommendation unit 350 may maintain the corresponding to-do recommendation even when a task related to the to-do meeting minutes is generated. In other words, in the example above, even if a task is generated for to-do recommendation b, meeting minutes A may still include to-do recommendations a and b; when a user retrieves meeting minutes A, to-do recommendations a and b may also be retrieved.

In one embodiment, the to-do recommendation unit 350 may convert the to-do meeting minutes into general meeting minutes when all to-do recommendations are removed from the to-do recommendation list. For example, when meeting minutes A include to-do recommendations a and b, and a user (e.g., a work participant) generates a task for to-do recommendation b, to-do recommendation b may be removed from meeting minutes A. Afterwards, when the user generates a task for to-do recommendation a, to-do recommendation a may be removed from meeting minutes A. As a result, if there are no more to-do recommendations in meeting minutes A, meeting minutes A may be automatically converted to general meeting minutes.

In one embodiment, when a new to-do recommendation list is generated according to a to-do recommendation request while specific meeting minutes are to-do meeting minutes, the to-do recommendation unit 350 may update the existing to-do recommendation list included in the specific meeting minutes to a new to-do recommendation list. The to-do recommendations related to the specific meeting minutes may change each time a to-do recommendation is requested due to condition changes, such as modification of meeting contents or time elapse; when a new to-do recommendation list is generated, the to-do recommendation unit 350 may update the existing to-do recommendation list included in the to-do meeting minutes into a new list. In other words, a user (e.g., a work participant) may request additional to-do recommendations even when specific meeting minutes already contain to-do recommendations, and the to-do recommendation unit 350 may generate new to-do recommendations in response to the additional request for the existing meeting minutes that already include to-do recommendations.

When a user's selection is entered through a selection option for each to-do recommendation, the task manager 370 may generate a task related to the corresponding to-do recommendation. The user may request generation of a task related to the to-do recommendation by selecting an activated selection option from the to-do recommendation list provided through the interface. The task manager 370 may initiate a task generation operation related to the to-do recommendation selected by the user through the selection option.

In one embodiment, the task manager 370 may designate the user who enters a user selection for each to-do recommendation as a task assigner of the corresponding task and set the corresponding to-do recommendations as the task contents. Tasks may be generated by including various work-related items. For example, a task may be generated by including a task assigner that generates the task, task contents, and the like. The task manager 370 may automatically set the user who requests task generation as the task assigner and automatically set the to-do recommendation as task contents.

In one embodiment, when a task is generated, the task manager 370 may grant the user who requests task generation the rights to modify task contents. In other words, a task may be updated even after its generation as a task generator additionally inputs other items to the task. For example, the task generator may specify a task performer responsible for completing the task-related work after the task is generated or may set a task deadline by which the task is expected to be finished.

In one embodiment, when the user selects a plurality of selection options, the task manager 370 may sequentially generate a task related to each of the to-do recommendations. If meeting minutes contain a plurality of to-do recommendations, the task generator may generate a task for each to-do recommendation by selecting a selection option for each to-do recommendation. In this case, the corresponding tasks may be generated sequentially according to the order in which the task generator selects the selection options. Also, the task manager 370 may generate a task by receiving task contents directly from the task generator in addition to the to-do recommendations; accordingly, a plurality of tasks related to meeting minutes may be sequentially generated.

In one embodiment, when a task related to the corresponding to-do recommendation is generated, the task manager 370 may add the remaining to-do recommendations in the to-do recommendation list to the specific meeting minutes to convert the specific meeting minutes into to-do meeting minutes. Basically, when a to-do recommendation list is provided according to a to-do recommendation request, a work participant may select a to-do recommendation to generate a task, and the remaining to-do recommendations for which no task has been generated may be removed without being saved. On the other hand, when a task related to a specific to-do recommendation is generated in conjunction with the to-do recommendation unit 350, the task manager 370 may add the remaining to-do recommendations of the to-do recommendation list to the specific meeting minutes to convert the specific meeting minutes to to-do meeting minutes. In other words, when task generation is completed, the task manager 370 may send a task generation completion signal to the to-do recommendation unit 350, and the to-do recommendation unit 350 may add the to-do recommendations in the to-do recommendation list to the general meeting minutes to convert them into to-do meeting minutes.

The controller (not shown in FIG. 3) may control the overall operation of the to-do recommendation device 130 and manage control flow or data flow through the user request receiver 310, user request processor 330, to-do recommendation unit 350, and the task manager 370.

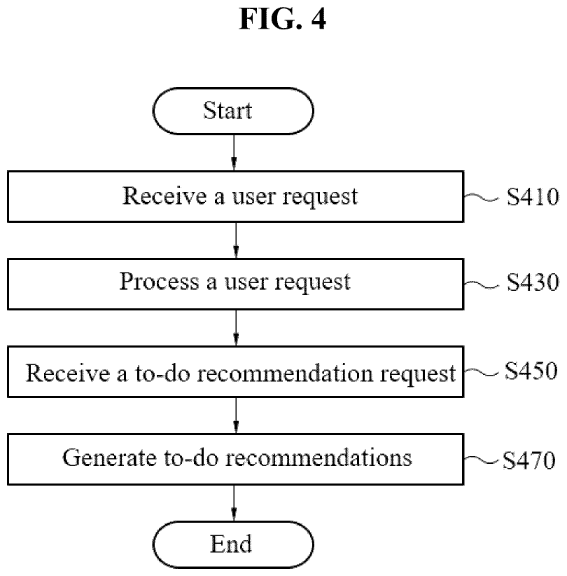

FIG. 4 is a flow diagram illustrating an artificial intelligence-based to-do recommendation method according to the present disclosure.

Referring to FIG. 4, in the S410 step, the to-do recommendation device 130 may receive a user request for generation or retrieval of meeting minutes from a user terminal 110. In the S430 step, the to-do recommendation device 130 may generate meeting minutes or a meeting minutes list including the meeting minutes according to the user request through the processor 210.

Also, in the S450 and S470 steps, the to-do recommendation device 130 may generate to-do recommendations related to the contents of the meeting minutes through an artificial intelligence model when a to-do recommendation request related to the meeting minutes is received from the user terminal 110 and provide a to-do recommendation list including selection options for each to-do recommendation to the user terminal 110.

In one embodiment, the to-do recommendation device 130 may generate a task related to the corresponding to-do recommendation when a user's selection is entered through the selection options for each to-do recommendation. At this time, the task generation operation may be performed through the task manager 370 of the processor 210.

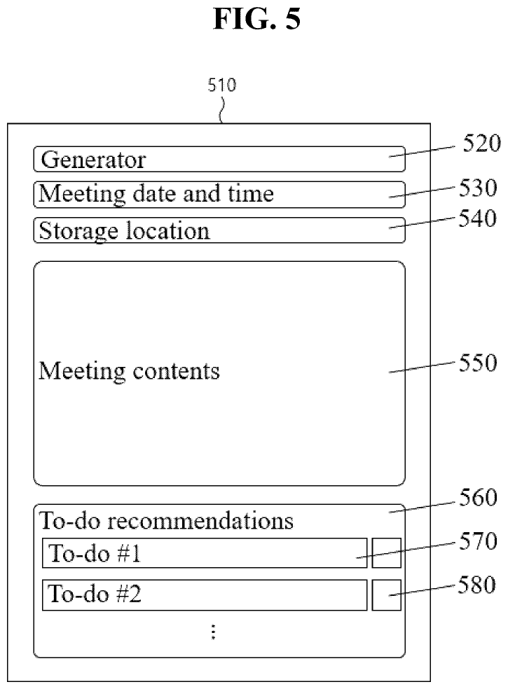

FIG. 5 illustrates one embodiment of meeting minutes according to the present disclosure.

Referring to FIG. 5, the to-do recommendation device 130 may retrieve and provide meeting minutes that record meeting contents 550 among work participants in response to a meeting minutes retrieval request. At this time, the meeting minutes 510 may be generated manually by work participants or automatically by an artificial intelligence model.

In one embodiment, as shown in FIG. 5, the meeting minutes 510 may be generated by including meeting contents 550 automatically summarized by the artificial intelligence model and to-do recommendations 560 recommended by the artificial intelligence model and may include various items. For example, the meeting minutes 510 may include a generator 520, meeting date and time 530, storage location 540, meeting contents 550, and to-do recommendations 560.

The generator 520 may correspond to a user who has generated the meeting minutes, which may correspond to one of the work participants involved in the meeting. Generator information may be automatically determined based on a meeting minutes generation request. The meeting date and time 530 represents when the meeting was held and may include the date, day, and time; the meeting date and time may be automatically determined based on the time of the meeting minutes generation request.

Also, the storage location 540 may correspond to a location where the meeting minutes 510 are generated and stored. For example, the storage location 540 may correspond to the information on the space (e.g., folder name) in which actual meeting minutes are stored within the user terminal 110 or to-do recommendation device 130; in some cases, the storage location 540 may be expressed as the information on a link that provides access to the meeting minutes 510.

Also, the meeting contents 550 may correspond to a summary of the meeting contents, automatically summarized by the artificial intelligence model and may correspond to text information generated through speech recognition from a conversation recording file that captures the meeting contents. The to-do recommendations 560 may correspond to to-do information automatically recommended by the artificial intelligence model and may include work information related to the meeting contents. The to-do recommendations 560 may be generated by including one or more specific to-dos 570 and selection options 580. The specific to-do 570 may briefly express the title or purpose of a to-do in the text form. The selection option 580 may be generated independently for each specific to-do 570 and may be implemented in various ways, using checkboxes or radio buttons.

Also, the meeting minutes 510 may include the meeting name or meeting participant information and may include various meeting minutes menus. For example, the meeting minutes menu may include a task generation reservation menu, a shared link generation menu, and an upload menu for files, images, and videos. At this time, the meeting minutes menus may be provided together with the meeting minutes when the meeting minutes are retrieved after generation of the meeting minutes.

The task generation reservation menu may correspond to a function that schedules task generation based on a specific point in time by a work participant with access rights after generation of the meeting minutes. In other words, if task generation is scheduled at time point A, a notification or a reminder for task generation may be provided to the work participants who have made the reservation at time point A. The shared link generation menu may correspond to a function that enables generation of a shared link providing direct access to the meeting minutes from outside. The upload menu may correspond to a function that enables adding files or images related to the meeting contents to the meeting minutes after generation of the meeting minutes.

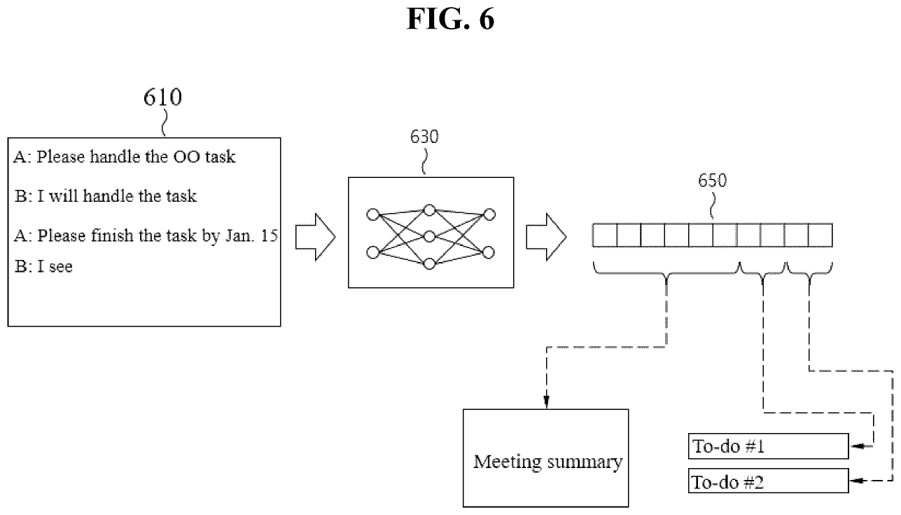

FIG. 6 illustrates one embodiment of a process for generating meeting minutes according to the present disclosure.

Referring to FIG. 6, the to-do recommendation device 130 may generate a summary of the meeting contents and to-do recommendations, respectively, through the artificial intelligence model 630. The to-do recommendation device 130 may receive a conversation recording file that captures the meeting contents among work participants along with a user request for generation of meeting minutes and convert the conversation recording file into text to generate conversation text 610 related to the meeting contents.

The to-do recommendation device 130 may provide the conversation text 610 as input to the artificial intelligence model 630 and generate a summary and to-do recommendations from the output of the artificial intelligence model 630. At this time, the artificial intelligence model may be built in advance based on a language model that receives text input and generates text output. The output of the artificial intelligence model may be generated in the form of an output vector 650 with dimensions of a specific size, and the to-do recommendation device 130 may use each component of the output vector 650 to generate a summary and one or more to-dos. Also, the input of the artificial intelligence model may also be converted into vector data extracted from the conversation text 610.

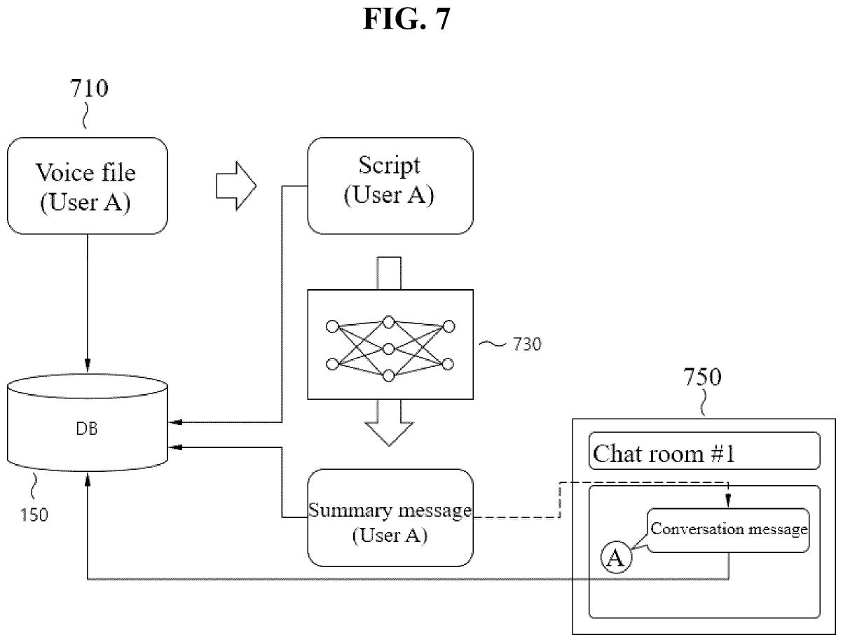

FIG. 7 illustrates one embodiment of a process for generating conversation messages according to the present disclosure.

Referring to FIG. 7, the to-do recommendation device 130 may receive user A's voice file 710 recorded on the user terminal 110. The to-do recommendation device 130 may recognize the speech of the voice file 710 and generate a script converted into text and a summary message. At this time, the summary message may be generated based on the script and may be generated through a pre-built speech recognition model 730. In other words, the speech recognition model 730 may be designed to receive a script as input and output a summary message summarizing the contents of the corresponding text. The to-do recommendation device 130 may display the summary message as a conversation message within the chat room 750 related to the user's selection.

Also, the to-do recommendation device 130 may store and manage scripts, summary messages, and conversation messages related to user A's voice file 710 in the database 150. When a conversation message is selected in the chat room 750, the to-do recommendation device 130 may search the database 150 to provide voice files, scripts, and summary messages related to the corresponding conversation message.

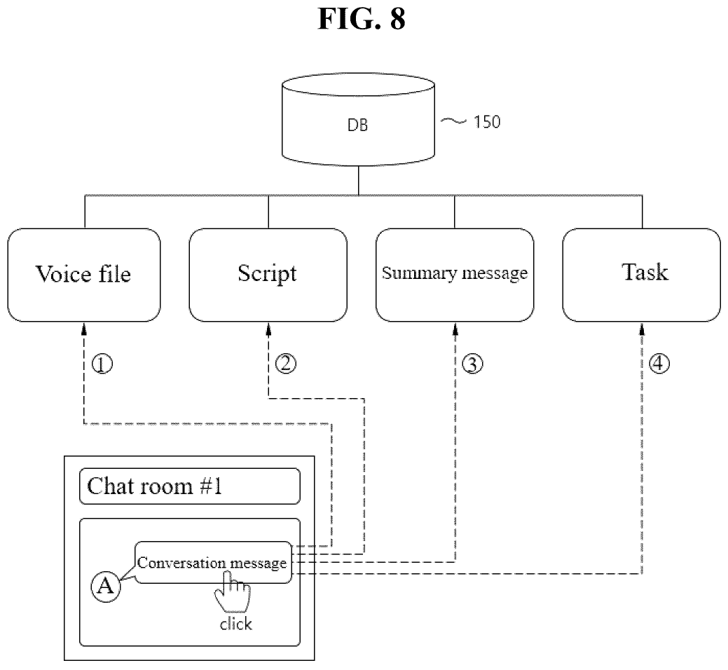

FIG. 8 illustrates one embodiment of a process for providing related functions in a chat room according to the present disclosure.

Referring to FIG. 8, when the to-do recommendation device 130 receives a selection of a conversation message from a participant of the chat room, the to-do recommendation device 130 may display an interface related to the conversation message. In this case, the interface may include functions related to the conversation message. For example, the interface may provide functions such as \textcircled{1} listening to a voice file, \textcircled{2} viewing a script, \textcircled{3} viewing a message, and \textcircled{4} generating a task; and the user may select a specific function to access the corresponding contents. The to-do recommendation device 130 may access the database 150, search for data related to the user's selection, and provide the information related to the user's selection through the user terminal 110.

Also, the to-do recommendation device 130 may restrict provision of an interface for users participating in the chat room if they do not have rights to access the corresponding conversation message. In other words, when a conversation message is selected by a user without access rights, the to-do recommendation device 130 may not perform the operation for providing an interface according to the user's message selection. To this end, when the to-do recommendation device 130 displays a conversation message related to a summary message through the chat room, the to-do recommendation device 130 may configure access rights for the corresponding conversation message.

In other words, when the to-do recommendation device 130 displays a summary message extracted from the user's voice file as a conversation message in the chat room, the to-do recommendation device 130 may allow access rights preconfigured by the user. For example, when a user records his or her voice and shares the recorded voice file as a conversation message through the chat room, access to the recorded voice file may be configured to be restricted for other users in the chat room, and the to-do recommendation device 130 may restrict the access rights for other users while displaying the corresponding conversation message in the chat room.

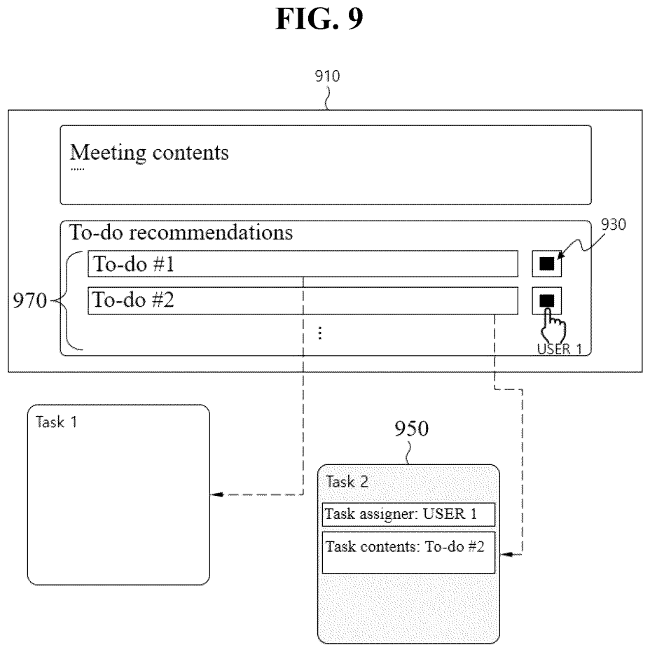

FIG. 9 illustrates one embodiment of a task generation process according to the present disclosure.

Referring to FIG. 9, the to-do recommendation device 130 may retrieve meeting minutes based on their classification as either general meeting minutes or to-do meeting minutes 910 according to whether or not to-do recommendations are included and then generate a retrieval result. Unlike general meeting minutes, the to-do meeting minutes 910 may include a to-do recommendation list 970 related to the meeting contents within the meeting minutes. In other words, work participants may check detailed items by selecting specific meeting minutes from a meeting minutes list provided as a result of retrieving meeting minutes and may generate related tasks by selecting part of the to-do recommendations included in the meeting minutes. Here, a task may correspond to the minimum unit of work related to a project.

Specifically, detailed items of the meeting minutes provided to work participants may include a summary of the meeting contents and to-do recommendations related to the meeting contents, and selection options 930, which may be selected individually, may be included for each to-do recommendation. At this time, the to-do recommendation device 130 may change the activation state of each to-do recommendation based on the work participant and provide the to-do recommendation with the changed activation state. For example, the to-do recommendation device 130 may activate the selection option 930 and provide the activated selection option 930 when a work participant has normal access rights or has high priority for the corresponding to-do recommendation. In other words, the activation state of the selection option 930 may correspond to a state in which a to-do recommendation may be selected by a work participant.

As shown in FIG. 9, when to-do #1 and to-do #2 are selected separately by a work participant (USER 1), the corresponding selection options 930 may be converted to a ‘selected’ state, and the to-do recommendation device 130 may generate tasks (Task 1 and Task 2) that match the corresponding to-dos. At this time, Task 2 may correspond to the task 950 generated in response to to-do #2 among the to-do recommendations. The corresponding task 950 may correspond to a task in a temporary state with some items left empty.

In this case, when the corresponding task 950 is generated, the task assigner may be automatically set to ‘USER 1’ who has requested generation of the corresponding task, and the task contents may be automatically configured based on the contents of ‘to-do #2’ selected by USER 1. Also, the corresponding task 950 may be generated and stored with information on the remaining items left empty, excluding the task assigner and task contents; the corresponding items may be entered later by the work participant (USER 1).

Meanwhile, the corresponding task 950 may be generated and stored with all items entered through additional input from the work participant, and some items may be generated but stored with empty contents according to the work participant's selective input.

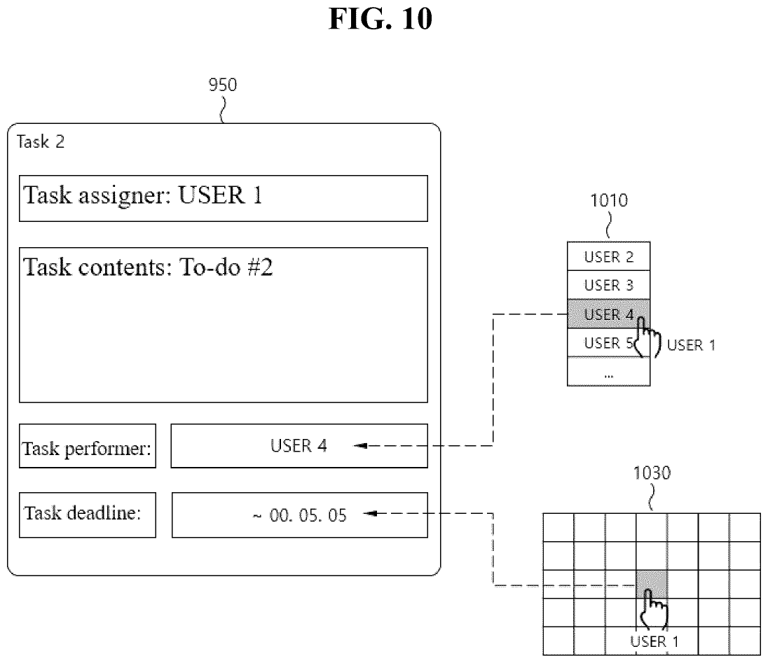

FIG. 10 illustrates one embodiment of a process for modifying a task according to the present disclosure.

Referring to FIG. 10, the to-do recommendation device 130 may generate a task 950 according to the work participant's selection for each to-do recommendation included in the meeting minutes. At this time, the to-do recommendation device 130 may allow task modification rights to the work participant who generated the task 950.

In the case of FIG. 10, the task 950 may be generated with the work participant ‘USER 1,’ who requested task generation for recommended ‘to-do #2’ of FIG. 9, set as a task assigner and the contents of the selected ‘to-do #2’ set as the task contents. Afterwards, the to-do recommendation device 130 may update the corresponding task 950 by receiving input for the empty items from the work participant ‘USER 1’ with task modification rights through the input interfaces 1010, 1030.

For example, the task performer may be set as another work participant ‘USER 4’ selected by work participant ‘USER 1’ on the first input interface 1010, and the task deadline may be set to ‘00.05.05’ as entered by work participant ‘USER 1’ on the second input interface 1030. In other words, the to-do recommendation device 130 may update the corresponding task 950 when the remaining information is input by a work participant.

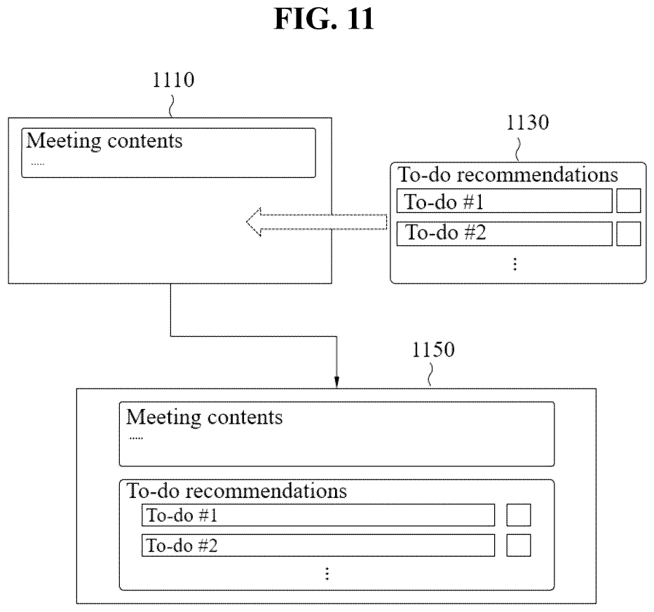

FIG. 11 illustrates general meeting minutes and to-do meeting minutes according to the present disclosure.

Referring to FIG. 11, the to-do recommendation device 130 may add a to-do recommendation list 1130 to general meeting minutes to convert the general meeting minutes 1110 into to-do meeting minutes 1150. The general meeting minutes 1110 may correspond to meeting minutes that do not include to-do recommendations, while the to-do meeting minutes 1150 may correspond to meeting minutes that include to-do recommendations. In other words, the to-do recommendation device 130 may initially generate and store general meeting minutes 1110 that do not include to-do recommendations. The to-do recommendation device 130 may convert general meeting minutes 1110 into to-do minutes 1150 by adding the to-do recommendation list 1130 to the general meeting minutes 1110 when a work participant requests conversion or specific conditions are met. In this case, the work participant may also check to-do recommendations related to the meeting minutes through a retrieval result for the meeting minutes and may easily generate tasks related to the to-do recommendations by selecting the to-do recommendations as needed.

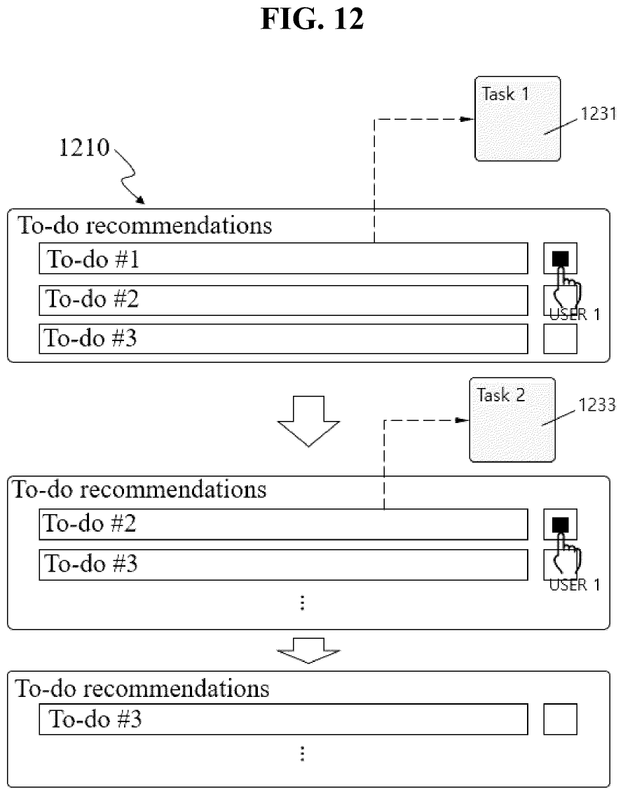

FIG. 12 illustrates one embodiment of a process for updating a to-do recommendation list according to the present disclosure.

Referring to FIG. 12, the to-do recommendation device 130 may remove a specific to-do recommendation from the to-do recommendation list 1210 when a task is generated by a work participant selecting the specific to-do recommendation on the to-do recommendation list 1210 included in the to-do meeting minutes. For example, as shown in FIG. 12, when the to-do recommendation list 1210 includes to-do #1, to-do #2, and to-do #3, work participant ‘USER 1’ may select the selection option for to-do #1 to generate a first task 1231 for to-do #1. The to-do recommendation device 130 may remove to-do #1 from the to-do recommendation list 1210 when generation of the first task 1231 for to-do #1 is completed.

Also, work participant ‘USER 1’ may select the selection option for to-do #2 and generate a second task 1233 for to-do #2. The to-do recommendation device 130 may remove to-do #2 from the to-do recommendation list 1210 when generation of the second task 1233 for to-do #2 is completed. If all to-do recommendations are removed from the to-do recommendation list 1210 due to sequential task generation for the remaining to-do recommendations that include to-do #3, the to-do recommendation device 130 may convert the to-do meeting minutes into general meeting minutes.

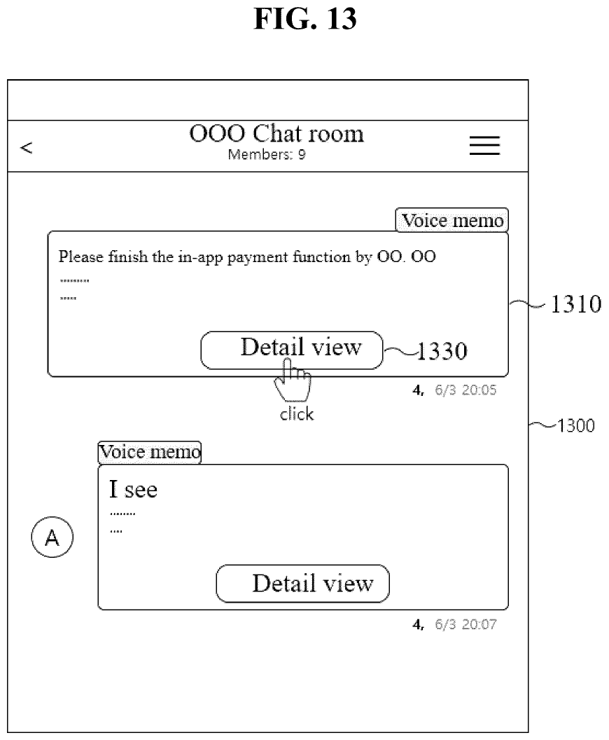

FIG. 13 illustrates a process of sharing conversation messages derived from user speech in a chat room according to the present disclosure.

Referring to FIG. 13, the to-do recommendation device 130 may share a conversation message 1310 generated from a user's voice file through a chat room 1300. In one embodiment, the conversation message 1310 generated as a result of recognizing the user's speech may be displayed as a ‘voice memo’ within the chat room 1300. In other words, the voice memo may include a summary result obtained by converting the user's speech into a text form and may be displayed in the form of a conversation message 1310 within the chat room 1300.

Also, the to-do recommendation device 130 may display the conversation message 1310 through the chat room 1300 and provide a detailed view page for the conversation message 1310. To this end, the to-do recommendation device 130 may provide a detailed view menu 1330 along with the conversation message 1310.

In other words, the user may access the detailed view page that provides details of the corresponding conversation message 1310 by selecting (e.g., clicking) the detailed view menu 1330 of the conversation message 1310. For example, on the detailed view page of the conversation message 1310, at least one of a voice file, a script, and a summary message related to the conversation message 1310 may be provided. At this time, access to the voice file, script, or summary message provided through the detailed view page may be restricted for other users according to the privacy settings set by the user who generated the corresponding conversation message 1310.

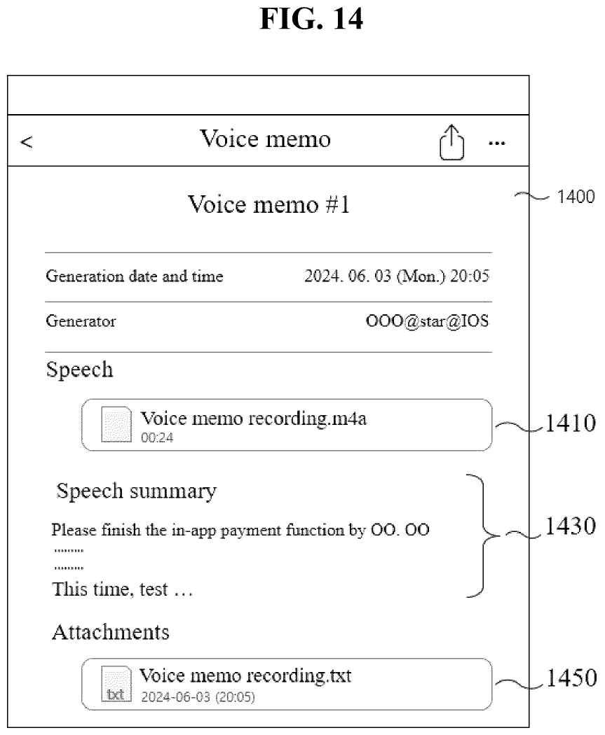

FIG. 14 illustrates one embodiment of a detailed view page of a conversation message according to the present disclosure.

Referring to FIG. 14, the to-do recommendation device 130 may provide a detailed view page 1400 for a conversation message. In one embodiment, a conversation message generated from user speech may be defined as a voice memo, and the following descriptions will be based on the voice memo.

More specifically, the detailed view page 1400 for the voice memo may be accessed by the user selecting a conversation message in the chat room. The detailed view page 1400 may provide detailed information related to the corresponding voice memo. For example, the detailed view page 1400 may display the title (e.g., voice memo #1), generation date and time, and generator of the corresponding voice memo, generation date and time, and generator. Also, the detailed view page 1400 may display the user's voice file 1410, summary message 1430, and script 1450 related to the corresponding voice memo.

The user may select the voice file 1410 displayed on the detailed view page 1400 to download the file itself and check the entire contents of the summary message 1430 and script 1450. If the total length of the script 1450 is long, the script 1450 may be converted into a file such as ‘voice memo recording.txt’ and attached to the detailed view page 1400. Also, if the voice memo is set to private by the generator, other users without access rights may be restricted from downloading the private voice file 1410, display of the private summary message 1430 may be restricted, and downloading of attachments related to the private script 1450 may be restricted.

Although the present disclosure has been described with reference to preferred embodiments given above, it should be understood by those skilled in the art that various modifications and variations of the present disclosure may be made without departing from the technical principles and scope specified by the appended claims below.

### DETAILED DESCRIPTION OF MAIN ELEMENTS

| | |
|---|---|
| 100: To-do recommendation system | |
| 110: User terminal | 130: To-do recommendation device |
| 150: Database | |
| 510: Meeting minutes | 610: Conversation text |
| 630: Artificial intelligence model | 650: Output vector |
| 730: Speech recognition model | 750: Chat room |
| 910: To-do meeting minutes | 930: Selection option |
| 950: Task | 970: To-do recommendation list |
| 1010: First input interface | 1030: Second input interface |
| 1110: General meeting minutes | 1130, 1210: To-do |
| | recommendation list |
| 1150: To-do meeting minutes | |
| 1231: First task | 1233: Second task |

1. An artificial intelligence-based to-do recommendation device, the device comprising:
a memory; and
a processor electrically connected to the memory,
wherein the processor is configured to:
receive a user request for generation or retrieval of meeting minutes from a user terminal,
generate the meeting minutes or a meeting minutes list including the meeting minutes according to the user request,
generate to-do recommendations related to the contents of the meeting minutes through an artificial intelligence model when a to-do recommendation request related to the meeting minutes is received from the user terminal, and
provide a to-do recommendation list including selection options for each to-do recommendation to the user terminal.

2. The device of claim 1, wherein the processor receives from the user terminal a conversation recording file capturing a conversation among work participants regarding the meeting contents along with a user request for generation of meeting minutes,
generates conversation text related to the meeting contents by converting the conversation recording file into text, and
generates meeting minutes including a summary of the conversation text and selection options for each to-do recommendation.

3. The device of claim 2, wherein the processor transmits the conversation recording file to an external Speech-To-Text (STT) server and receives the conversation text from the STT server.

4. The device of claim 1, wherein the processor generates the meeting minutes list in response to a retrieval request from any one of work participants on a chat room or a meeting map for management of meeting minutes in which the work participants participate.

5. The device of claim 1, wherein, if the meeting minutes correspond to general meeting minutes, the processor adds the to-do recommendation list to the meeting minutes and converts the corresponding meeting minutes into to-do meeting minutes.

6. The device of claim 5, wherein, if a task is generated for a specific to-do recommendation included in the to-do meeting minutes, the processor removes the specific to-do recommendation from the to-do recommendation list.

7. The device of claim 6, wherein, when all to-do recommendations are removed from the to-do recommendation list, the processor converts the to-do meeting minutes into the general meeting minutes.

8. The device of claim 1, wherein, when a user selection is input through the selection option for each to-do recommendation, the processor generates a task related to the corresponding to-do recommendation.

9. The device of claim 8, wherein the processor sets the user who has entered the user selection as a task assigner of the task and sets the corresponding to-do recommendation as the contents of the task.

10. The device of claim 8, wherein, when a plurality of selection options are selected by the user who has entered the user selection, the processor sequentially generates tasks for each of the corresponding to-do recommendations.

11. The device of claim 1, wherein the processor receives the user's voice file related to the meeting contents from the user terminal,
recognizes the speech within the voice file to generate a script and a summary message converted to text, and
displays the summary message as a conversation message in a chat room selected by the user.

12. The device of claim 11, wherein the processor receives the user's speech through streaming from the user terminal in real-time and generates the voice file.

13. The device of claim 11, wherein the processor inputs the voice file into a pre-built speech recognition model to generate the script and the summary message, respectively.

14. The device of claim 11, wherein the processor generates a tag associated with the summary message to combine the tag with the summary message and
provides a retrieval function for the summary message through the tag.

15. The device of claim 11, wherein the processor assigns and stores a favorites function to each conversation message and
provides a list of conversation messages to which the favorites functions have been assigned through a favorites page.

16. An artificial intelligence-based to-do recommendation method performed in a to-do recommendation device comprising:
a memory; and
a processor electrically connected to the memory,
the method, performed by the processor, comprising:
receiving a user request for generation or retrieval of meeting minutes from a user terminal;
generating the meeting minutes or a meeting minutes list including the meeting minutes according to the user request; and
generating to-do recommendations related to the contents of the meeting minutes through an artificial intelligence model when a to-do recommendation request related to the meeting minutes is received from the user terminal and
providing a to-do recommendation list including selection options for each to-do recommendation to the user terminal.
